(19) United States
(12) Patent Application Publication
(10) Pub. No.: US 2005/0010441 A1
(43) Pub. Date: Jan. 13, 2005

(54) System and method for displaying the census of a healthcare facility

(76) Inventor: Judy Wheeler, Anacortes, WA (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/759,532

(22) Filed: Jan. 20, 2004

Related U.S. Application Data
(63) Continuation of application No. 09/685,058, filed on Oct. 9, 2000, now abandoned.

(51) Int. Cl. G06F 17/60

(52) U.S. Cl. 705/2

(57) ABSTRACT

Computer executable software code stored on a computer readable medium of a computer, the code for generating a graphical user interface. The graphical user interface includes a plurality of room representations that each correspond to a room in a healthcare facility. Each of the room representations communicates a number of beds in a corresponding room and identifiers of occupants of the beds in the corresponding room. The graphical user interface also includes an area communicating at least one of admits, discharges, bed holds, and room changes.

### BACKGROUND OF THE INVENTION

1. Field of the Invention

The present invention relates to a system that displays healthcare related information, and more particularly to a system that displays the census of a healthcare facility.

2. Description of the Related Art

Healthcare facilities utilize census information that enumerates the population of residents (i.e., patients) in the facility as well as demographic information of the residents. Examples of census information include the location and name of the residents in a facility, the insurance status of residents, the availability or unavailability of a particular room or bed in the facility, the overall occupancy of the facility or a particular department or ward, and the number of admits and discharges. Because the staff of healthcare facilities rely on census information on a daily basis, effective communication of census information to the staff is critical to the proper operation of healthcare facilities.

Census information of healthcare facilities is typically tracked with some form of a census information system. For example, some healthcare facilities use white boards, chalk boards, or name tag boards to collect and monitor census information. These systems are handwritten, require the manual adjustment of name tags or the like, are time consuming, and prone to error. These census information systems also limit the information communicated to the staff. For example, some electronic versions of these systems typically only provide information relating to the location of a resident in the facility. The staff must consult other systems or various paper reports to obtain other relevant information, such as resident insurance status, room or bed availability, the gender of residents in a given room, and the number of admits and discharges. As a result, it is inefficient and burdensome for staff to access needed census information during the daily operation of healthcare facilities.

The above-described problems are even more pronounced in post-acute healthcare facilities. Post-acute healthcare facilities typically have different shifts of staff that care for residents over a much longer period of time than a typical hospital facility. Hence, the census information of post-acute healthcare facilities must be continually monitored and assessed to ensure the efficient operation of post-acute healthcare facilities.

Some insurance providers, such as Medicare, will only reimburse health care facilities for services rendered to covered residents if the bed the resident occupies is certified, i.e., met certain standards specified by the insurance provider or other organization. Post-acute healthcare facilities seek certification, such as Medicare certification, for some or all of the beds in the facility such that they are eligible to receive reimbursement for residents occupying certified beds. For example, many post-acute healthcare facilities certify 10 to 25 percent of the facility's beds. The staff continuously monitors the occupancy and availability of the certified beds to ensure that residents covered by insurance programs like Medicare are placed in the certified beds and that the facility receives reimbursement for these residents. Because of the foregoing, the staff continually needs to know which residents are covered by insurance programs, which beds in the facility have been certified, and which pending admits are covered under insurance programs so that they can be assigned to the certified beds. Because current census information systems do not adequately communicate this information to the staff of post-acute healthcare facilities, it is problematic to efficiently match insured residents and pending admits with certified beds.

Some post-acute care facilities permit residents to hold or reserve a post-acute care bed for a future stay, such as immediately after a hospital stay. The staff of the post acute-care facility thus needs to be informed as to which beds are being held so as to prevent new admits from being assigned to reserved beds. Current census information systems of post-acute healthcare facilities fail to adequately communicate these bed holds.

It will thus be appreciated that it is particularly difficult for staff in healthcare facilities, especially post-acute healthcare facilities, to make decisions based on the census information provided by current census information systems.

### SUMMARY

In an effort to address the aforementioned problems, the embodiments of the present invention strive to provide a system whereby staff in a healthcare facility can perform healthcare tasks, such as the administration of a department or ward, with the assistance of a graphical user interface that communicates census information related to the residents, rooms, and beds in the healthcare facility. Since some healthcare facilities utilize different shifts of staff, the graphical user interface enables any staff member to quickly visualize any changes that have happened in the facility.

Other objects, advantages and features associated with the embodiments of the present invention will become more readily apparent to those skilled in the art from the following detailed description. As will be realized, the invention is capable of other and different embodiments and its several details are capable of modification in various obvious aspects, all without departing from the invention. Accordingly, the drawings and the description are to be regarded as illustrative in nature, and not limitative.

### BRIEF DESCRIPTION OF THE DRAWINGS

FIG. 1 is a schematic of a healthcare facility in accordance with an embodiment of the present invention.

FIG. 2 is a schematic of a census information system in accordance with one embodiment of the present invention.

FIG. 3 is an example of a graphical user interface rendered in accordance with one embodiment of the present invention.

### DETAILED DESCRIPTION

FIG. 1 illustrates an embodiment of a healthcare facility 5 suitable for implementing the features of the present invention. The healthcare facility 5 includes one or more departments or wards 10, 12, a staff administration area 20, and several rooms 101-148. The physical layout of the wards and rooms depends on the particular healthcare facility. As will be appreciated, the organization and number of wards and rooms on a floor will vary between healthcare facilities.

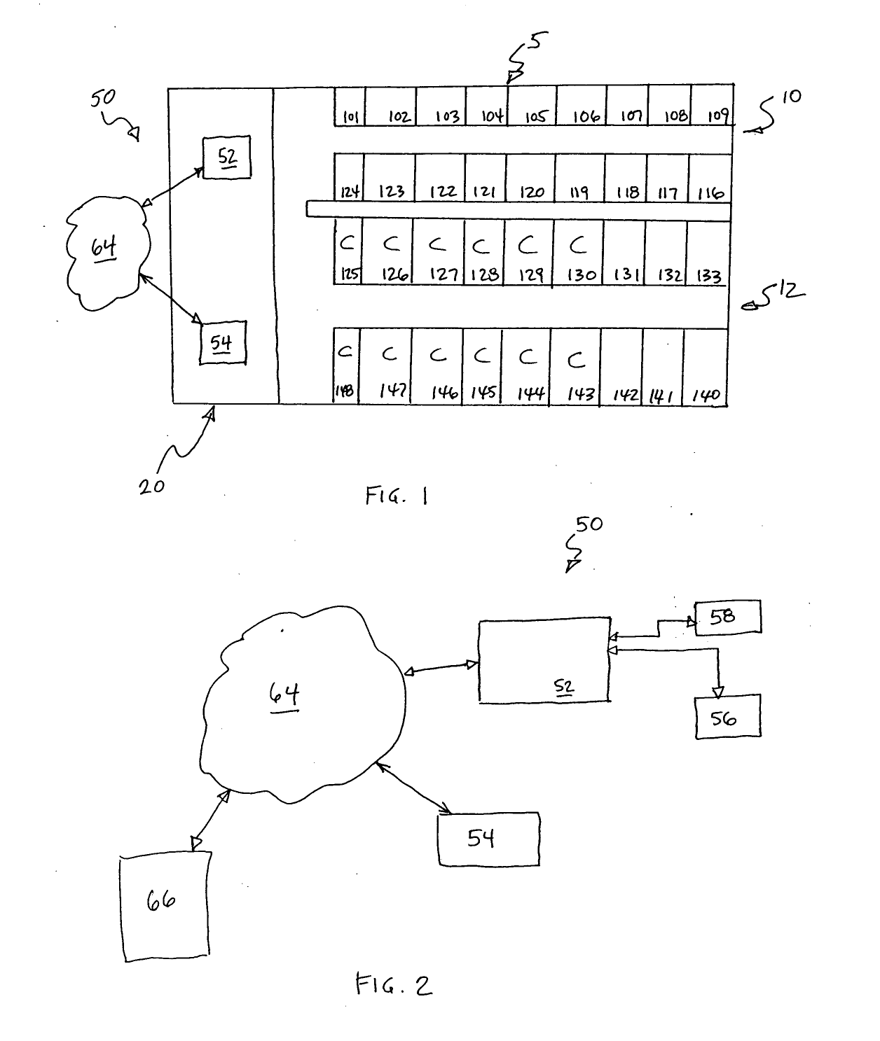

The staff administration area 20 includes a resident information system 50, one embodiment of which is illustrated in further detail in FIG. 2. The census information system 50 is a system that stores census information of the healthcare facility 5, which is utilized by the staff of the facility to manage the healthcare facility 5. Hence, the census information system 50 includes one or more servers, computers, or other electronic devices capable of receiving and storing the census information. In one embodiment, the census information system 50 is a WINDOWS based system. The census information system 50 may also be internet-based and generate web-browser and web page data, such as HTML, JavaScript, Java applets, etc.

In the illustrated embodiment, the census information system 50 includes one or more workstations or computers 52, 54 that are connected to a server 66 via a network 64. Suitable implementations of computers 52, 54 include devices such as desktop computers, laptop computers, wired or wireless telephones, portable workstations, personal data assistants (“PDA's”), pagers, and various other electronic communication devices capable of carrying out healthcare related activities.

The computers 52, 54 are each operable by a staff member and each include a user input device, an output device, and a memory. The user input device 56 may be any type of input device, including a keyboard, keypad, mouse, touch screen, etc. The output 58 may be any type of output device capable of rendering a graphical user interface, such as a computer monitor, etc. The computers 52, 54 are connected to a printer or similar device for generating a hard copy of the graphical user interface rendered on the output device of the respective computers 52, 54.

Network 64 may be any form of interconnecting network including an intranet, such as a local or wide area network, or an extranet, such as the World Wide Web or the Internet. Network 64 can be physically implemented on a wireless or wired network on leased or dedicated lines, including a virtual private network (VPN). Server 66 may be any sort of storage device for facilitating network prescription transactions, including a plurality of servers, a single server with multiple storage devices, or computers distributed over a network. Server 66 may also coexist within one or more of the communication workstations 52, 54.

The server 66 includes computer executable software code that generates a graphical user interface on the output devices of the computers 52, 54. The software code is stored on a computer readable medium of the server 66 and/or one or more of the computers 52, 54. As described in further detail below, the code enables the output devices of the computers 52, 54 to generate a graphical user interface containing census information of the healthcare facility 5.

In an alternative embodiment, the system 50 does not include the server 66 and the network 66. Rather, the code for generating the graphical user interface containing the census information is resident on each of the computers 52, 54. In another embodiment, the code is at least partially located on the server 66, which is remote from the facility 5 and is operated by an application service provider over the Internet.

The census information stored by the census information system 50 at least includes resident identifiers of different residents, and room representations that each correspond to a room in the healthcare facility 5. The census information system 50 preferably stores other census information as well. For example, the census information system 50 may store any combination of the following information:

resident identifiers;

resident gender;

resident payor;

previous resident payor;

current resident room assignment;

previous resident room assignment;

room identifiers;

bed identifiers;

number of available beds;

number of unavailable beds;

number of occupied beds;

number of bed holds;

bed capacity of the facility;

bed certification;

bed hold;

admission times;

discharged times;

date resident on leave;

prior facility admissions;

upcoming facility admissions; and

upcoming facility discharges.

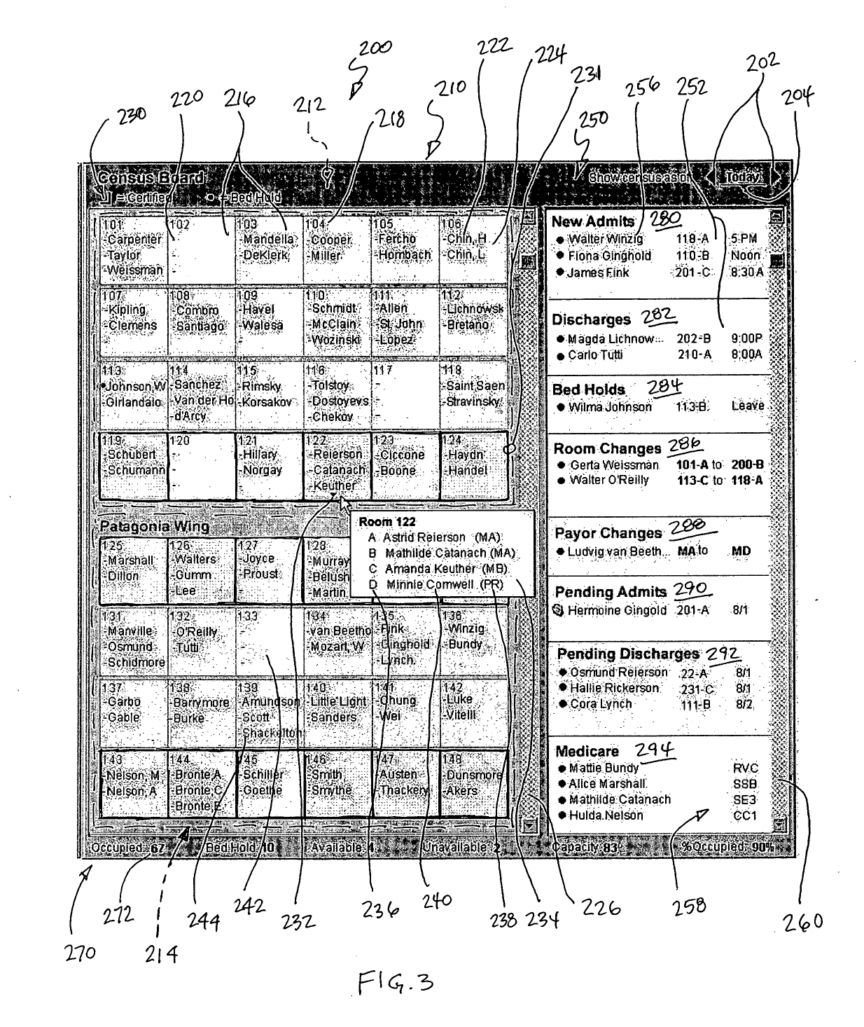

Any one of or combination of the above-described census information stored by the census information system 50 may be rendered on the graphical user interface of the computers 52, 54. FIG. 3 illustrates one embodiment of a graphical user interface 200 (“GUI”) rendered by the census information system 50, which the staff at the healthcare facility 5 would view on the output devices of the computers 52, 54 during operation of the system 50. The staff at the healthcare facility 5 can print out a report representative of the GUI 200.

The GUI 200 includes a location portion 210 and a resident summary portion 250. The location portion 210 is a window or area on the GUI 200 that includes a plurality of room representations 216. In the preferred embodiment, the room representations 216 are illustrated as blocks. As will be appreciated, the room representations may be any shape and/or size and still function as contemplated herein.

In FIG. 3, grouped areas 212, 214 of room representations 216 correspond to the two departments 10, 12 of the healthcare facility 5. The location portion 210 includes a scroll bar 226 that enables the user to view any other departments in the facility (not illustrated). In an alternative embodiment of the GUI 200, the location portion 210 may be separated into one or more windows or areas. For example, each department 10, 12 of the facility may displayed in a separate window.

Each room representation 216 includes a room identifier 218. The room identifiers 218 of the room representations 216 are preferably the same as the rooms 101-148 in the facility 5. Hence, each room representation 216 corresponds to an actual room 101-148 in the facility 5. For example, the room representation 216 containing room identifier “103” corresponds to facility room 103 illustrated in FIG. 1. In the illustrated embodiment, the room identifiers 218 are numbers. In an alternative embodiment, the room identifiers 218 are reference characters, such as one or more letters or combinations of letters and numbers.

In the preferred embodiment, each room representation 216 includes one or more bed indicators 220. The number of bed indicators 220 displayed in a room representation 216 corresponds to the number of beds in the corresponding room in the facility 5. In the illustrated embodiment, checks or dashes are used as bed indicators 220. For example, as illustrated in FIG. 3, the room representation 216 containing identifier “101” includes three bed indicators 220 such that a staff member viewing the GUI 200 can determine that room 101 of the facility 5 contains three beds.

The location portion 210 of the GUI 200 also includes resident identifiers 222 that are used to identify residents or occupants of the facility 5. Each resident identifier 222 uniquely identifies a resident. In the preferred embodiment, each resident identifier 222 is a particular resident's name. In alternative embodiments, the resident identifiers are other unique identifying mechanisms, such as numbers, codes, or pictures.

Preferably, the resident identifiers 222 are displayed relative to the bed indicators 220 as illustrated in FIG. 3. When a resident is admitted into the healthcare facility, the resident is assigned to a particular bed in one of the rooms 101-148. After the demographic information for the new resident has been input into the census information system 50 and/or other applicable facility systems, the resident identifier 222 for the resident is illustrated next to a bed indicator 218 in the GUI 200. For example, if “Ms. Carpenter” is admitted to the facility and assigned to room 101, then the identifier “Carpenter” is shown next to a bed indicator 218 in the room representation 216 corresponding to room 101. It will be appreciated that a user can click on a resident identifier 222 and drag the identifier 222 to another bed designator in a different room representation such that a user can easily change the GUI 200 to reflect a resident's room change.

As discussed above, the census information system 50 stores information relating to the gender of each resident. In the preferred embodiment, the location portion 210 communicates information regarding the gender of the residents in each room. One or more gender identifiers are used to designate whether a room includes all male, all female, or some male and some female residents.

In the preferred embodiment, the location portion 210 utilizes different colors as the gender identifiers designating the genders of the occupants of the rooms. A first color, such as blue, is used to designate male residents, and a second color, such as pink, is used to designate female residents. For a room in which all of the occupants are male, the interior of the corresponding room representation 216 is blue. On the other hand, for a room in which all of the occupants are female, the interior of the corresponding room representation 216 is pink. If a combination of male and female residents are assigned to a room, such as a husband and wife combination, then half of the interior of the room representation is pink and the other half of the interior is blue.

In alternative embodiments, visual indicia other than color are used to designate the gender of the residents. For example, indicia such as shading, highlighting of the resident identifier, symbols (such as male and female symbols), or any other marking may be used. It will also be appreciated that colors other than blue and pink can be used.

In the preferred embodiment of the GUI 200, additional indicia or indicators are used with the room representations 216 to communicate additional census information. The GUI 200 includes bed hold indicia 228 designating that a bed is on hold for a future or new resident. In the illustrated embodiment, the bed hold indicia 228 is a red dot displayed in a room representation 216 that corresponds to a room that has a bed on hold for a particular resident. The bed indicator 220 corresponding to a bed that is on hold is replaced with a bed hold indicia 228. For example, as illustrated in FIG. 3, room 113 includes a bed hold indicia 228 for resident “Johnson, W”. In an alternative embodiment, bed hold indicia is located in a position separate from the bed indicator 220. The inclusion of the bed hold indicia 228 in the GUI 200 advantageously informs the staff of the post acute-care facility as to which beds are being held so as to prevent new admits from being assigned to reserved beds.

The GUI 200 also communicates information designating those beds in the healthcare facility 5 that are certified by an insurance program, such as Medicare. Some insurance providers, such as Medicare, will only reimburse health care facilities for services rendered to covered residents if the bed the resident occupies is certified, i.e., met certain standards specified by the insurance provider or other organization. Some forms of certification give federal or state governments the right to inspect the beds in the facility to assure compliance with federal or state care regulations. Reimbursement under such insurance programs is based on costs to the healthcare facility. Typically, residents who are covered under these insurance programs are of higher acuity than average residents. A healthcare facility usually certifies only a portion of the facility to isolate the higher costs related to caring for the particular residents.

Post-acute healthcare facilities seek certification, such as Medicare certification, for some or all of the beds in the facility such that they are eligible to receive reimbursement for residents occupying in certified beds. The staff continuously monitor the occupancy and availability of the certified beds to ensure that residents covered by insurance programs like Medicare are placed in the certified beds and that the facility receives reimbursement for these residents. Accordingly, the staff continually needs to know which residents are covered by insurance programs, which beds in the facility have been certified, and which pending admits are covered under insurance programs so that they can be assigned to the certified beds.

To communicate to a user those beds that are certified relative to those beds that are not certified, the location portion 210 includes a certification identifier 230 as illustrated in FIG. 3. In the preferred embodiment, the certification identifier 230 is a border 231 around the room representations 216 corresponding to rooms in the facility 5 with beds that have been certified. For example, FIG. 3 illustrates a border 231 around room representations 119-124 and 143-148 that designates the beds of the healthcare facility 5 that are certified for reimbursement. Accordingly, the staff viewing the graphical user interface can determine that the beds in rooms 119-124 and 143-148 in the healthcare facility are certified and thus that beds 101-118 and 125-142 are not certified.

The GUI 200 also communicates information relating to the occupancy of the beds in the rooms 101-148 of the facility 5. Examples of such information include: an unoccupied room; an unavailable room; a double booked bed; and additional beds.

As discussed above, in the preferred embodiment, the interior of a room representation 216 is a particular color or colors to reflect the gender of one or more occupants in the corresponding room of the facility 5. If a particular room in the facility 5 is unoccupied, then no resident identifiers 222 are displayed in the corresponding room representation 216. In addition, the interior of the corresponding room representation 216 is a different color, such as yellow, than the remainder of the room representation corresponding to occupied rooms. By utilizing a different color for unoccupied rooms, it is easier for the user to obtain an overall assessment of the occupancy of the rooms in the facility and the locations of the unoccupied rooms and unoccupied beds. Similarly, the interior of a room representation 216 corresponding to a room that is unavailable or out of service is a different color, such as gray, than the remainder of the room representations.

In the preferred embodiment, the location portion 210 also includes an identifier or indicia for the double booking of a bed. The color of the font of the resident identifiers 222 for residents who have been assigned to the same bed is different from the other resident identifiers. For example, the color of some of the resident identifiers 222 in room representations “135” and “139” in FIG. 3 are different than other identifiers. That is, residents “Ginghold” and “Lynch” in room 135 in the facility 5 have been assigned to the same bed such that the bed is double booked. In an alternative embodiment, the resident identifiers 222 for double booked beds are a different size or shape than the remainder of resident identifiers.

Occasionally, a room in one facility may have more beds than other rooms in another facility. Depending on the number of beds in a particular room and the size of the room representations 216, some of the bed indicators 220 may not be displayable in the configuration of the location portion 210. In such cases, the location portion 210 includes an additional bed indicator 232 as illustrated in FIG. 3. The additional bed indicator 232 is a mark that alerts the user of the census information system 50 that one or more additional beds, not viewable in the room representation 216, are available for a particular room. It will be appreciated that other information relating to the residents and the rooms may be displayed, such as: a shared bathroom indicator; an indicator for resident catagion; and an indicator for a resident needing long-term care.

As illustrated in FIG. 3, the GUI 200 also includes a resident identifier window 234 having additional information relating to the residents in a particular room. The window 234 operates similar to a conventional tool tip that is utilized with standard applications on a computer. Different windows 234 appear and disappear as a cursor or pointer hovers over a particular field in the location portion 210, as will be appreciated. For example, as illustrated in FIG. 3, the arrow pointer is moved over the room representation corresponding to room 122 and held in place. After a brief period of time, a window 234 opens on the graphical user interface. The window 234 that opens corresponds to the particular room representation that the arrow pointer is over. The window 234 shown in FIG. 3 corresponds to the room representation for room “122.” Once the arrow pointer is moved away from the room representation for room “122,” the window 234 disappears.

Many types of information may be included in window 234. In the preferred embodiment, the window 234 includes a bed indicator 236, a resident designator 240, and an insurance payor 238. It will be appreciated that the window may also include other census information such as from the resident demographics. In the illustrated embodiment, the bed indicators 236 in window 234 are letters. Preferably, the quantity of letters is the same as the quantity of beds in the corresponding room. The resident designators 240 in the window 234 are preferably the full names of each of the residents in the corresponding room. The window 234 also includes a primary payor identifier 238 that represents the primary insurance payors of the residents in the room. A code indicative of the particular primary payor is displayed adjacent to the appropriate resident's name. In FIG. 3, the primary payor identifier 238 is a two letter code. For example, the primary payor identifier 238 for “Minnie Cornwell” is “PR.” In an alternative embodiment, the identifier 238 is a numerical code. In a further embodiment, the window 234 includes photographs of the residents in the corresponding room.

The census information system 50 also stores historical resident and facility information so that the information concerning the past location of residents can be viewed on the GUI 200. Hence, the GUI 200 may display the census of the facility 5 on a particular day in the past. To achieve this display, the GUI 200 includes date scroll icons 202 and a date selection icon 204 that enable the user to select a GUI 200 for displaying the census of the facility on a particular day. In FIG. 3, the census board for “Today” (i.e., the date of viewing by a user) is displayed. The date scroll icons 202 enable the user to move forward or backward on a day-by-day basis. The date selection icon 204 is an interactive icon that drops down a monthly calendar in response to a user selection. The monthly calendar enables the user to select a particular date without scrolling to the date on a day-by-day basis.

The GUI 200 also includes a resident summary portion 250. The resident summary portion 250 is generated from the information in the census information system 50. The resident summary portion 250 includes several categories 252 of residents of the facility. Each category 252 includes a category title 254. The census information system 50 processes the stored census information into the categories 252.

In the preferred embodiment, the resident summary portion 250 includes several areas adjacent to each other, each representing a different category 252 of residents. In FIG. 3, the categories 252 are illustrated in a list format. A scroll bar 260 is provided to allow the user to view the various categories 252 in the list. As will be appreciated, the categories 252 may be listed in any particular order. In the preferred embodiment, the user of the GUI 200 can rearrange the order of categories 252 by clicking on a category 252 and dragging it to a different position in the resident summary portion 250. Additionally, each category 252 of the resident summary portion 250 may be displayed in its own area separate from the other categories 252, and different categories 252 may be displayed on different sides of the location portion 210.

As illustrated in FIG. 3, categories 252 of the resident summary portion 250 include: new admits 280; discharges 282; bed holds 284; room changes 286; payor changes 288; pending admits 290; pending discharges 292; and residents covered by a federally subsidized insurance 294, such as Medicare. The list of categories illustrated in FIG. 3 is not an exhaustive list of the different categories that may be included in the GUI 200. Also, the information that can be displayed for each category is not limited to the illustrated information or the information described in detail below.

The first category 280 is “New Admits.” Residents who have been admitted to the healthcare facility on a particular day are considered to be new admits on that day. In FIG. 3, three resident names are displayed in the “New Admits” category 280. In the illustrated embodiment, room and bed location information and the time of admission are displayed for each of the newly admitted residents listed in this category 280. In an alternative embodiment, resident who have been admitted to the healthcare facility 5 with a certain limited and predetermined time period, such as the previous 24 hours, rather than that day, are shown.

The second category 282 is “Discharges”, which includes residents who have been discharged on the day for which the GUI 200 is generated. In FIG. 3, the names of the discharged residents, their room and bed locations, and the time of discharge are listed in the category “Discharges” 282. Similarly, in an alternative embodiment, residents who have been discharged with a certain limited and predetermined time period, such as 24 hours, may be shown.

The third category 284 is “Bed Holds.” Post-acute care facilities permit residents to hold or reserve a post-acute care bed for a future stay, such as immediately after a hospital stay. Beds that are reserved for a particular resident for a future stay are termed “Bed Holds.” Because the staff of the post acute-care facility needs to be informed as to which beds are being held so as to prevent new admits from being assigned to reserved beds, the name of the resident or residents whose bed is on hold is displayed in category “Bed Holds” 284. Similar to the previous categories, the room and bed location of the resident whose bed is on hold is also listed in category 284.

The fourth category 286 is “Room Changes.” Because the staff of the post acute-care facility needs to know the current or up-to-date location of specific residents, category 286 displays the name of the resident or residents that has been assigned a new room within a limited and predetermined time period, such as the current day, or within the past 24 hours. Category 286 also displays the resident's previous room and bed assignment and new room and bed assignment such that the user can identify the past and current room and bed assignments for those residents that have changed rooms within the predetermined time period.

The fifth category 288 is “Payor Changes.” The format of this information is similar to that in the room changes category. Each resident who has changed payors is identified along with the previous and current payors in category 288.

The sixth category 290 is “Pending Admits,” which includes residents that are scheduled to be admitted into the healthcare facility. A “Pending Admit” designation for a resident is indicative of the status of a resident at a particular time during the admission process. The relevant time period for the pending admits category is determined by the census information system 50. For example, residents who are scheduled to be admitted to the facility within the next two days may be considered in the “Pending Admits” category. Alternatively, the “Pending Admits” time period may be extended or shortened depending on the user preferences. Furthermore, if the staff designates a resident as a pending admit, then the resident retains that status regardless of time. The resident identifier, scheduled room, bed location, and scheduled date of admittance are displayed for each resident with a scheduled admittance date within the time period for “Pending Admits.”

The seventh category 292 is “Pending Discharges.” The resident identifier, current room, bed location, and scheduled date of discharge are displayed for each resident with a scheduled discharge date within a particular time period for “Pending Discharges.”

The last category 294 illustrated in FIG. 3 lists those residents having a predetermined insurance provider, such as the federally subsidized insurance program, “Medicare.” The Medicare program has numerous different levels of coverage, each of which has its own code. The three character codes displayed in the Medicare category in FIG. 3 are some of the codes for the different levels of coverage. By including the coverage codes, the staff of the facility can easily view the different levels of coverage required for the residents in the facility.

The GUI 200 also includes a census portion 270. The census portion 270 concerns the overall occupancy of the facility and is illustrated in the lower portion of the GUI 200 in a text based format. Alternatively, the census portion 270 may be positioned anywhere on the GUI 200. Moreover, the census portion 270 may be graphical or pictorial representation of the occupancy of the facility. In the illustrated embodiment, the census portion 270 includes occupancy information 272, the format of which may be modified based on the user's preferences. The occupancy information 272 may include any combination of the following information:

number of occupied beds;

number of beds on hold;

number of available beds;

number of unavailable beds;

capacity of the facility (number of total beds); and

percentage of total beds occupied.

Any one of or combinations of the above-described information is stored by the census information system 50 and may be communicated to computers 52, 54 and displayed as part of a graphical user interface. As an additional note, a bed may be categorized as unavailable by a facility if it is inoperable, under repair, etc.

As will be appreciated from the foregoing, the GUI 200 rendered by the embodiments of the present invention offers the advantage of displaying the location portion 210 in conjunction with the resident summary portion 250 such that the staff of the healthcare facility 5 can simply and efficient access, view, and track up-to-date census information for the facility 5. Thus, the changing staff of a healthcare facility can rely on the displayed census information to ensure the proper operation of the healthcare facility without the burdensome and inefficient consulting of various printed reports or different medical systems. Additionally, by viewing categories of residents, such as “Pending Admits” or “Medicare”, and the layout of the rooms in the facility 5 at the same time, the staff can easily and quickly determine where to assign incoming residents, view any recent changes, and view the overall status of the facility. The staff can also easily determine whether there are any problems, such as double booking of rooms, or residents covered by a reimbursable insurance program like Medicare in non-certified beds.

The principles, preferred embodiments, and modes of operation of the present invention have been described in the foregoing description. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims be embraced thereby.

1. Computer executable software code stored on a computer readable medium of a computer, the code for generating a graphical user interface, the graphical user interface comprising:
a plurality of room representations that each correspond to a room in a healthcare facility, each of the room representations communicating a number of beds in a corresponding room and identifiers of occupants of the beds in the corresponding room; and
an area communicating at least one of admits, discharges, bed holds, and room changes;
the plurality of room representations and the area being simultaneously displayed, with each visible in its entirety.

2. The computer executable software code of claim 1, the graphical user interface further comprising historical information relating to a past location of occupants in the facility.

3. (Canceled)

4. The computer executable software code of claim 1, the area communicating admits and discharges.

5. The computer executable software code of claim 1, the area communicating bed holds.

6. The computer executable software code of claim 1, the area communicating room changes.

7. The computer executable software code of claim 1, if one or more rooms of the healthcare facility has no occupants, then the room representation corresponding to the one or more rooms that have no occupants including an indicator representing that the one or more corresponding rooms have no occupants.

8. The computer executable software code of claim 1, the room representations including a series of adjacent blocks.

9. The computer executable software code of claim 8, the blocks each containing a plurality of indicators that each correspond to a bed in the corresponding room.

10. The computer executable software code of claim 9, the identifiers including occupants' names.

11. The computer executable software code of claim 1, the area communicating admits, discharges, bed holds, and room changes.

12. Computer executable software code stored on a computer readable medium of a computer, the code for generating a graphical user interface, the graphical user interface comprising:
a plurality of room representations that each correspond to a room in a healthcare facility, each of the room representations communicating a number of beds in a corresponding room, identifiers of occupants of the beds in the corresponding room, and at least one gender identifier representing the gender of one or more occupants in the corresponding room;
an area communicating at least one of admits, discharges, bed holds, and room changes;
the plurality of room representations and the area being simultaneously displayed, with each visible in its entirety.

13. The computer executable software code of claim 12, the gender identifier being at least one of a first color and a second color, the first color corresponding to one or more male occupants and the second color corresponding to one or more female occupants.

14. The computer executable software code of claim 12, the graphical user interface further comprising:
a certification indicator designating beds of the healthcare facility that are certified for reimbursement.

15. (Canceled)

16. Computer executable software code stored on a computer readable medium of a computer, the code for generating a graphical user interface, the graphical user interface comprising:
a plurality of room representations that each correspond to a room in a healthcare facility, each of the room representations communicating a number of beds in the corresponding room and identifiers of occupants of the beds in the corresponding room; and
a certification indicator designating beds of the healthcare facility that are certified for reimbursement;
an area communicating at least one of admits discharges, bed holds, and room changes;
the plurality of room representations and the area being simultaneously displayed, with each visible in its entirety.

17. The computer executable software code of claim 16, the certification indicator including a border outlining room representations corresponding to rooms having beds that are certified for reimbursement.

18. The computer executable software code of claim 17, the graphical user interface further comprising:
at least one gender identifier representing the gender of one or more occupants in the corresponding room.

19. The computer executable software code of claim 18, the gender identifier being at least one of a first color and a second color, the first color corresponding to one or more male occupants and the second color corresponding to one or more female occupants.

20. The computer executable software code of claim 16, the graphical user interface further comprising:
an area communicating occupants that are eligible for reimbursement under a health insurance program.

21. The computer executable software code of claim 20, the health insurance program being a federal health insurance program.

22. A computer program product having computer-executable software code stored thereon for use with a computer, the code comprising:
code that enables the computer to display a plurality of room representations that each correspond to a room in a healthcare facility, each of the room representations communicating a number of beds in a corresponding room and identifiers of occupants of the beds in the corresponding room;
code that enables the computer to display in conjunction with said display of the plurality of room representations an area communicating at least one of admits, discharges, bed holds, and room changes;
code that enables the computer to display at least one gender identifier representing the gender of one or more occupants in the corresponding room; and
code that enables the computer to display a certification identifier designating beds of the healthcare facility that are certified for reimbursement;
the plurality of room representations and the area being simultaneously displayed, with each visible in its entirety.

23. The computer program product of claim 22, further comprising code that enables the computer to display historical information relating to a past location of occupants in the facility.

24. A method of displaying information relating to the census of a healthcare facility, comprising:
displaying a plurality of room representations that each correspond to a room in a healthcare facility, each of the room representations communicating a number of beds in a corresponding room and identifiers of occupants of the beds in the corresponding room; and
displaying an area communicating at least one of admits, discharges, bed holds, and room changes;
the plurality of room representations and the area being simultaneously displayed, with each visible in its entirety.

25. (Canceled)

26. The method of claim 24, further comprising:
displaying at least one gender identifier representing the gender of one or more occupants in the corresponding room.

27. The method of claim 24, said displaying an area communicating admits.

28. The method of claim 24, further comprising:
displaying a certification identifier designating beds of the healthcare facility that are certified for reimbursement.

29. The method of claim 28, said displaying a certification indicator including displaying a border that outlines room representations corresponding to rooms having beds that are certified for reimbursement.

30. The method of claim 24, said displaying an area communicating discharges.

31. The method of claim 24, further comprising:
displaying a location of occupants in the facility on one or more previous days.

32. The method of claim 24, further comprising:
displaying a numerical number of occupied beds, a numerical number of available beds, and a numerical number of unavailable beds in the facility.

33. The method of claim 24, said displaying an area communicating bed holds.
